(19) United States
(12) Patent Application Publication
(10) Pub. No.: US 2008/0228515 A1
(43) Pub. Date: Sep. 18, 2008

(54) FISHING CERTIFICATION PROCESSING METHOD, PROCESSING APPARATUS, AND RECORDING MEDIUM RECORDING PROCESSING PROGRAM

(75) Inventor: Daichi TACHIKAWA, Sapporo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/041,223

(22) Filed: Mar. 3, 2008

(30) Foreign Application Priority Data
Mar. 9, 2007 (JP) JP2007-059744

(51) Int. Cl. G06Q 99/00

(52) U.S. Cl. 705/1

(57) ABSTRACT

A fishing certification processing method certifying a fishing period and a fishing position of aquatic animals and plants. The fishing certification processing method includes acquiring position history information in which positions of a fishing boat under way are recorded and operation history information in which operation states of fishery facilities of the fishing boat are recorded, determining, after referring to a fishing pattern information storage unit for storing fish species fishing pattern information in which operation patterns of the fishery facilities can be set, whether there is a period in which an operation state satisfying an operation pattern in the fish species fishing pattern information is recorded, and extracting, based on a determination result of the fishing pattern-, positions at a time in the period of the operation state matching the fish species fishing pattern information from the position history information as the fishing positions.

### CROSS-REFERENCE TO RELATED APPLICATIONS

This application is related to and claims the benefit of priority from Japanese patent application no. 2007-59744, filed on Mar. 9, 2007, the entire contents of which are incorporated herein by reference.

### BACKGROUND OF THE INVENTION

### Field of the Invention

The embodiments relate to an issuing system of a certificate certifying a fishing area and a fishing method of aquatic animals and plants.

### SUMMARY

According to an aspect of an embodiment a fishing certification processing method is provided certifying a fishing period and a fishing position of aquatic animals and plants. The fishing certification processing method includes acquisitioning operation history, determining a fishing pattern, and extracting a fishing position.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating an example configuration of an embodiment;

FIG. 2 is a block diagram illustrating configuration example of a fishing certification processing apparatus and fishing boat terminal;

FIG. 3 is a table illustrating a data configuration example of fish species/fishing method information;

FIG. 4 is a table illustrating a data configuration example of fishing pattern information by fish species/fishing method;

FIG. 5 is a table illustrating a data configuration example of marine state optimal range information;

FIG. 6 is a table illustrating a data configuration example of position history information;

FIGS. 7A and 7B are tables illustrating data configuration examples of operation history information;

FIG. 8 is a table illustrating a data configuration example of marine state information acquired by a marine state information acquisition unit;

FIG. 9 illustrates an example display of “Sea surface temperature” of the marine state information using isothermal lines of sea surface temperatures at a certain date/time;

FIG. 10 illustrates an example display of “Chlorophyll concentration” of the marine state information using isoconcentration lines of chlorophyll concentrations at a certain date/time;

FIG. 11 is illustrating an example processing of a fishing boat terminal 2;

FIG. 12 is a block diagram illustrating an example of a certificate issuance request screen;

FIG. 13 is a flow chart illustrating an example processing of a fishing certification processing apparatus;

FIG. 14 is a flow chart of an example certification determination processing for fishing by a squid angling method;

FIG. 15 is a flow chart of determination processing of an optimum zone;

FIG. 16 illustrates an example fish species/fishing method table;

FIG. 17 illustrates an example fishing pattern table;

FIG. 18 illustrates an example position history information;

FIG. 19 illustrates an example engine operation history information;

FIG. 20 illustrates an example fishery facility operation history information;

FIG. 21 illustrates an example optimum zone table;

FIG. 22 illustrates an example marine state information table;

FIG. 23 is a diagram illustrating an output example of a fishing certificate;

FIG. 24 is a flowchart illustrating an example certification determination processing for fishing by a Pacific saury square net fishing method;

FIG. 25 is a flowchart illustrating an example certification determination processing for fishing by a skipjack pole-and-line fishing method; and

FIG. 26 is a flow chart of an example position information check processing.

### DETAILED DESCRIPTION OF THE EMBODIMENT

Reference will now be made in detail to the embodiments, examples of which are illustrated in the accompanying drawings, wherein like reference numerals refer to the like elements throughout. The embodiments are described below to explain the present invention by referring to the figures.

Currently, with substantial traceability of agricultural products available, consumers demand safer food.

However, in a case of aquatic animals and plants (hereinafter referred to simply as “fish”), it is generally difficult to trace a fishing position. The fishing position often refers to a landing port identifying a fishermen's cooperative to which a fishing boat belongs, instead of the position where fish was actually caught. To identify the actual fishing position, there possibly unreliable reports of a concerned fisherman have been used to identify the fishing position.

Moreover, based on fishing circumstances in recent years, an increase in catch quantities of fish or a price hike thereof cannot be expected. Thus, a strategy to stabilize fishery management by developing brand fish species (differentiation) to increase the selling price on the market has been viewed as promising. This is because quality of fish generally depends on the fishing position, time, fishing method, and the like—even if the fish species is the same. Thus the fish price differ widely depending on the fishing position, time, and fishing method. Transactions can reflect quality of fish by providing the fish whose quality is as high as possible to the market while the quality thereof is maintained.

Quality information showing quality of caught fish can be reported to the fishing port for landing before temporal natural deterioration starts and transactions are immediately made based on the quality information.

Printing of a producing district can be used. However, this usually requires a printer for printing a label showing the producing district/processing location of produced foodstuffs being installed at a predetermined producing district or processing location.

Traceability of fish demanded on the market and to establish/maintain “fish brands” indicating a certain level of quality of fish dealt on the market, a way to objectively certify the time when the fish was actually caught, the position (area of sea), the fishing method and the like is desired.

However, the actual fishing position of fish has conventionally been a fishing port for landing fishes or a position that is identified based on a self-report of a fisherman and is never certified objectively. Thus, there has been a possibility that the fishing position is stated falsely, easily. A method of addressing this problem is desired.

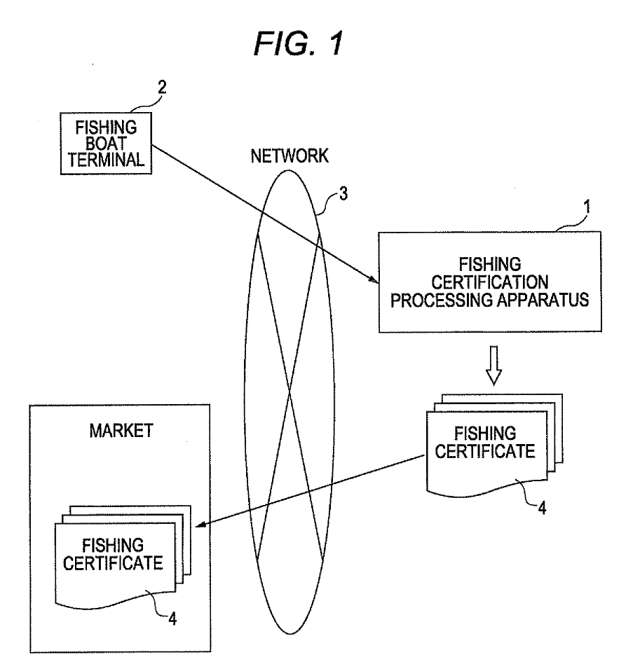

FIG. 1 is a diagram showing a configuration example of an example embodiment.

A fishing certification processing system according to an example embodiment includes a fishing certification processing apparatus 1 and a fishing boat terminal 2 mounted on a fishing boat. The fishing boat terminal 2 transmits data to the fishing certification processing apparatus 1 via a network 3.

The fishing certification processing apparatus 1 acquires position history information of the fishing boat, operation history information of fishing facilities and the like from the fishing boat terminal 2 of a fishing boat that makes a fishing certification request by specifying the fish species and fishing method. Then, based on the acquired information, the fishing certification processing apparatus 1 identifies the position where the fishing boat operated (fishing) and determines whether fishing of the specified fish species is possible at the identified position by the specified fishing method. Then, if the fishing of the specified fish species is possible at the identified position by the specified fishing method, the fishing certification processing apparatus 1 issues a fishing certificate 4 certifying that the fishing by the fishing boat has been carried out at the identified position by the specified fishing method. When fish to be certified are dealt on the market, the fishing certificate 4 is printed, e.g., in a predetermined format and attached to a transport container of the fish or the like.

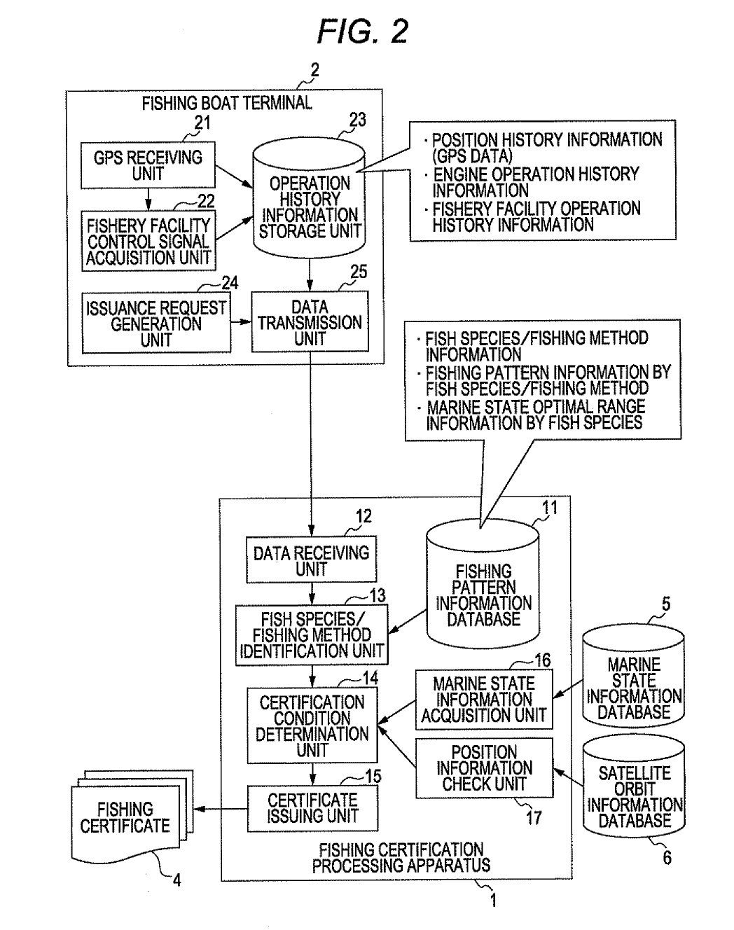

FIG. 2 is a diagram showing a configuration example of the fishing certification processing apparatus 1 and the fishing boat terminal 2.

The fishing certification processing apparatus 1 can be a computer including a CPU and a memory and includes a fishing pattern information database 11 including by software programs or the like, a data receiving unit 12, a fish species/fishing method identification unit 13, a certification condition determination unit 14, a certificate issuing unit 15, a marine state information acquisition unit 16, and a position information check unit 17.

The fishing pattern information database 11 is a processing unit storing fish species/fishing method information in which the fishing method is set for different fish species, fishing pattern information by fish species/fishing method showing conditions for determining whether t fishing corresponding to an operation pattern of fishing facilities including an engine of a fishing boat during fishing has been carried out for each fish species and fishing method, and marine state optimal range information in which the range of marine state in which fish can be caught is set for different fish species.

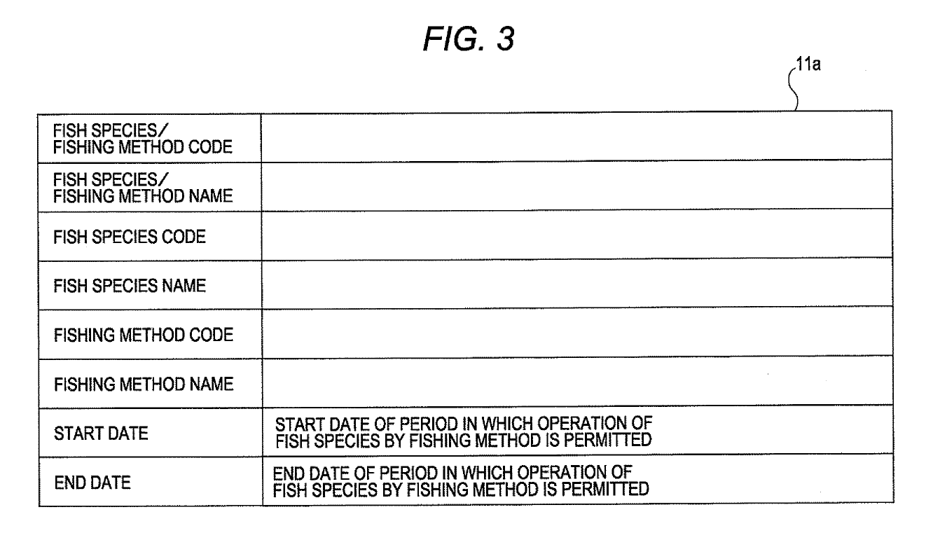

FIG. 3 is a diagram showing a data configuration example of fish species/fishing method information. In a data table 11a of the fish species/fishing method information (fish species/fishing method table), for different groups of the fish species and fishing method, the fish species/fishing method code identifying each group of the fish species and fishing method, the name of the group of the fish species and fishing method (fish species/fishing method name), the fish species code identifying the fish species, the name of the fish species (fish species name), the fishing method code identifying the fishing method, the name of the fishing method (fishing method name), the start date and end date of a period in which an operation of the fish species by the fishing method is permitted can be set.

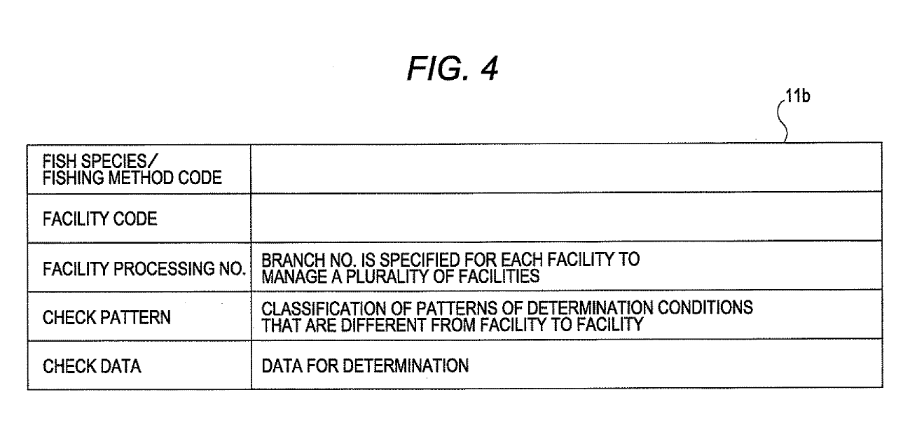

FIG. 4 is a diagram showing a data configuration example of fishing pattern information by fish species/fishing method. In a data table 11b of the fishing pattern information by fish species/fishing method (fishing pattern table), for different groups of the fish species and fishing method, the fish species/fishing method code, the facility code identifying the fishing boat's engine and fishery facility used for the fishing method, the facility processing number identifying processing performed by the facility for each fishing boat's engine and fishery facility, check patterns showing after classifying patterns of determination conditions of operations, states, and the like in processing performed in each facility, and values (check data) used for determination processing can be set.

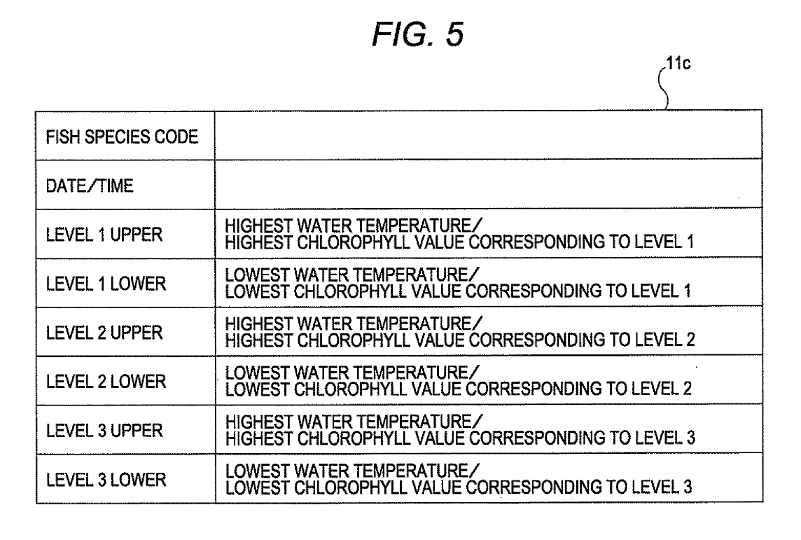

FIG. 5 is a diagram showing a data configuration example of marine state optimal range information. In a data table 11c of the marine state optimal range information (optimum zone table), for each fish species, the date/time showing the applicable period, the level 1 upper showing an upper limit of the range of marine state in which fishing is possible (optimal range), similarly the level 1 lower showing a lower limit of the optimal range and the like can be set. In the optimum zone table 11c, a plurality of optimal ranges having different upper and lower limits for the same marine state can be set, for example, as the level 2 and level 3. In this case, the upper and lower limits showing levels of each optimal range can be like “level 2 upper, level 2 lower”, “level 3 upper, level 3 lower” and the like.

The data receiving unit 12 receives an issuance request of the fishing certificate 4, operation history information and the like transmitted from the fishing boat terminal 2.

The issuance request includes the boat number of the fishing boat and the fish species, fishing method, and fishing period to be certified.

The operation history information includes position history information in which a history of positions of the fishing boat using GPS (global positioning system) is recorded, engine operation history information in which a history of operation states of the fishing boat's engine is recorded, and fishery facility operation history information in which a history of operation states of the fishery facility installed in the fishing boat is recorded.

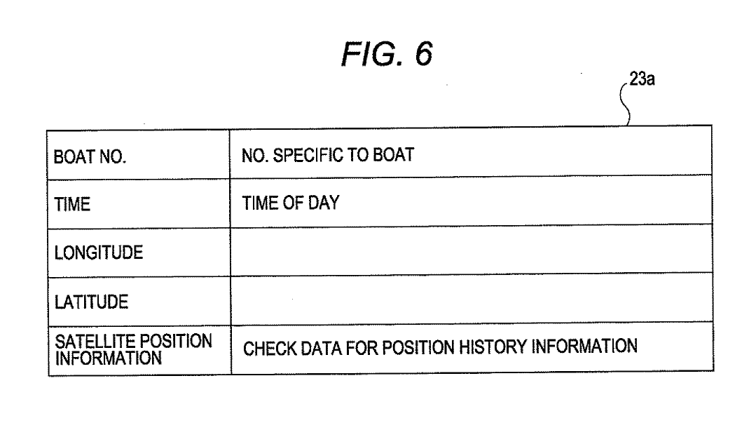

FIG. 6 is a diagram showing a data configuration example of position history information. In position history information 23a, in addition to the boat specific number (boat number) identifying the boat, the reception time of a received GPS signal, longitude, latitude, and satellite position information (GSV line) can be recorded. The longitude and latitude can be used to identify the position of the boat and the satellite position information is used to check for falsification of the position history information by the position information check unit 17.

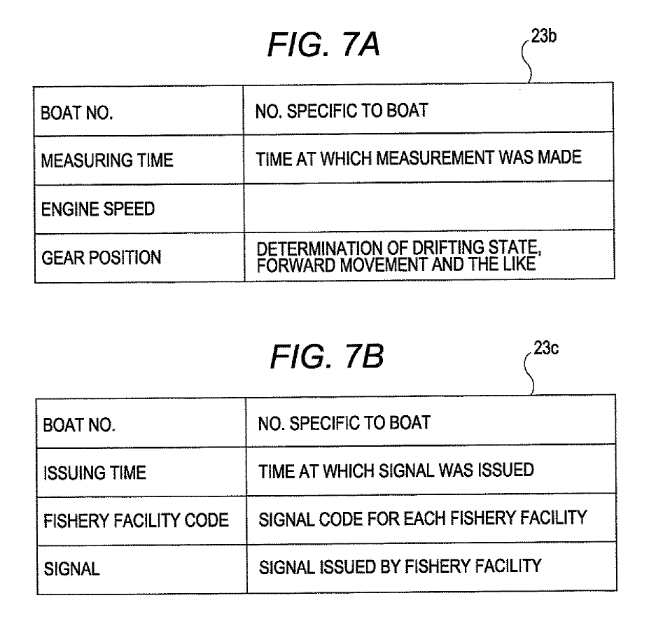

FIGS. 7A and 7B are tables illustrating data configuration examples of operation history information. FIG. 7A is a data configuration example of engine operation history information. In engine operation history information 23b, the boat number, measuring time, engine speed, and gear position showing the gear state are recorded. The gear position is used, together with the engine speed, to determine whether the fishing boat has been drifting (gear position=neutral (N)) or moving forward (gear position=1, 2, 3, . . . ) and, together with fishery facility operation history information, to determine whether fishing by a specific fishing method has been carried out.

FIG. 7B is a data configuration example of the fishery facility operation history information. In fishery facility operation history information 23c, the boat number, time (issuing time) at which a control signal has been issued, the fishery facility code for identifying a signal of each fishery facility, and a control signal (signal) issued by each fishery facility are recorded.

The fishery facility code can be set, for example, with “1” for a “Casting net machine” and “2” for a “Net-hauling winch.” The signal can be set, for example, with “1” for “Turn on the facility (ON),” and “3” for “Turn off the facility (OFF),” and “4” for “Start net casting.” Operating fishing facilities, operation content during operation, operation periods and the like are identified from signals of each fishery facility. Operation patterns obtained by combining these operation states are used to determine whether fishing by a specific fishing method is carried out.

The fish species/fishing method identification unit 13 refers to the fish species/fishing method table 11a of the fishing pattern information database 11 to identify the fish species/fishing method of the requested fishing. Also, whether or not the requested fishing has been carried out in a period of operation permit is determined.

The certification condition determination unit 14 refers to the fishing pattern table 11b and optimum zone table 11c of the fishing pattern information database 11 to identify the fishing period and fishing position of the requested fishing.

More specifically, the certification condition determination unit 14 can determine whether any pattern of the operation state satisfying check patterns and check data set in the fishing pattern table 11b is recorded in the engine operation history information and fishery facility operation history information and, if an applicable operation state is recorded, acquires the corresponding period (fishing period). Then, the certification condition determination unit 14 can identify the fishing position, e.g., by extracting the position at a time in the period corresponding to the fishing period acquired from the position history information.

Further, the certification condition determination unit 14 can refer to marine state information acquired from a marine state information database 5 by the marine state information acquisition unit 16 described later to determine whether or not the marine state at each extracted position is within the optimal level (range of the level 1 to 3 settings) of the optimum zone table 11c. Then, the certification condition determination unit 14 extracts positions corresponding to the marine states within the range of level settings of the optimal range as fishing positions.

The marine state information is information indicating the state of a predetermined area concerning items measuring marine conditions. In the present embodiment, the sea surface temperature (Celsius temperature (° C.)) and chlorophyll concentrations (mol) can be used.

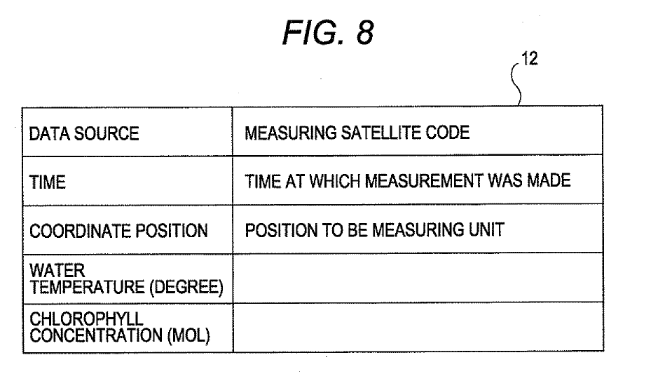

FIG. 8 is a table showing a data configuration example of marine state information acquired by the marine state information acquisition unit 16. In the marine state information, the data source showing the measuring satellite code identifying the measuring satellite to be a transmission source of the data, time at which the data has been measured, and measured values of predetermined measurement items can beset.

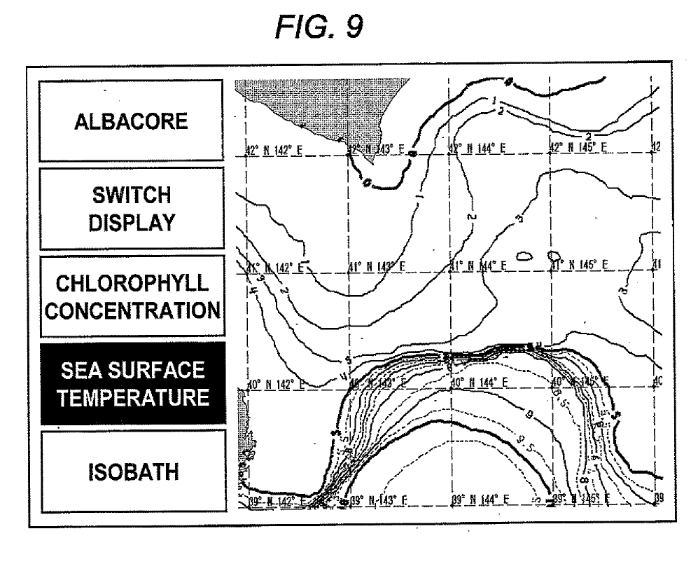

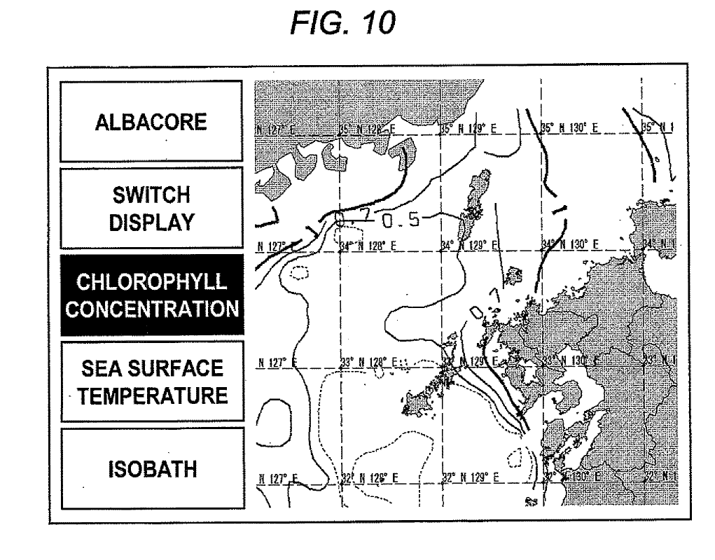

FIG. 9 is an example displaying the measurement item “Sea surface temperature” using isothermal lines of sea surface temperatures at a certain date/time, and FIG. 10 is an example displaying the measurement item “Chlorophyll concentration” using isoconcentration lines of chlorophyll concentrations at a certain date/time.

The certificate issuing unit 15 outputs the fishing certificate 4 identifying the fishing period and fishing position to be certified for the requested fishing of the fish by the fishing method.

For the specified caught fish species and fishing method, the fishing period (fishing start date/time, fishing end date/time) and fishing position (longitude and latitude) identified for the fishing, the water temperature when the fishing boat has been in the fishing position and the like are output to the fishing certificate 4. Also, the person who has operated (fisherman), fishing boat name, fishing port from which the fishing boat has gone for fishing, time at which the fishing boat has gone for fishing, fishing port for landing fishes, time at which fishes have been landed, and sailing distance may be output.

The marine state information acquisition unit 16 acquires marine state information as shown in FIG. 8 from the external marine state information database 5.

The position information check unit 17 can acquire orbit information of the GPS satellite of GPS from an external satellite orbit information database 6 and calculates the position when the information of the GPS satellite related to the GPS information of position history information has been transmitted from the orbit information. Then, the position information check unit 17 compares the calculated position of the GPS satellite and the position recorded in the satellite position information of the position history information to determine whether or not the position history information has been falsified. If there is a contradiction in comparison results, it is determined that falsification has occurred and the certification condition determination unit 14 terminates, e.g., without performing certification condition determination processing.

The fishing boat terminal 2 can be a computer including a CPU and a memory and include a GPS receiving unit 21 comprising software programs, a fishery facility control signal acquisition unit 22, an operation history information storage unit 23, an issuance request generation unit 24, and a data transmitting unit 25.

The GPS receiving unit 21 receives a GPS signal at predetermined times to store the GPS signal in the operation history information storage unit 23 as position history information 23a.

The fishery facility control signal acquisition unit 22 acquires a control signal issued by fishery facilities facility from the fishing boat engine or fishery facility to store the control information in the operation history information storage unit 23 as engine operation history information 23b or fishery facility operation history information 23c.

The issuance request generation unit 24 generates an issuance request of the fishing certificate 4 by identifying the caught fish species, fishing method and the like.

The data transmitting unit 25 transmits a certification issuance request, the position history information 23a, the engine operation history information 23b, and the fishery facility operation history information 23c to the fishing certification processing apparatus 1 via the network 3 or a storage medium.

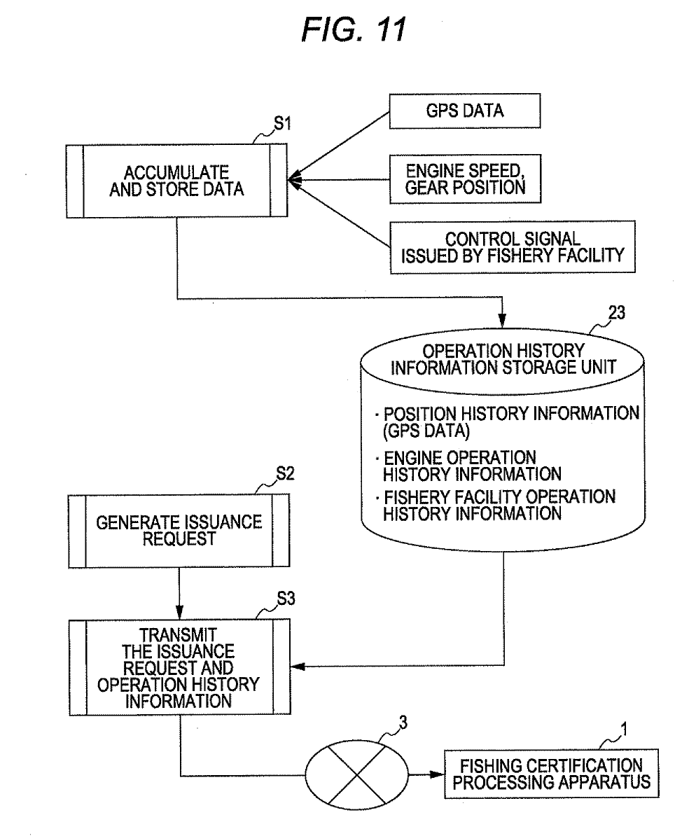

FIG. 11 is a showing an example processing by the fishing boat terminal 2.

In the fishing boat terminal 2, the position history information (GPS data) 23a collected by the GPS receiving unit 21, the engine operation history information (such as the engine speed and gear position of the fishing boat engine) 23b and the fishery facility operation history information (such as the control signal and values of each fishery facility) 23c collected by the fishery facility control signal acquisition unit 22 are stored in the operation history information storage unit 23 (operation S1).

The issuance request generation unit 24 displays a certificate issuance request screen and, after information is input, can generate an issuance request of the fishing certificate 4 (operation S2).

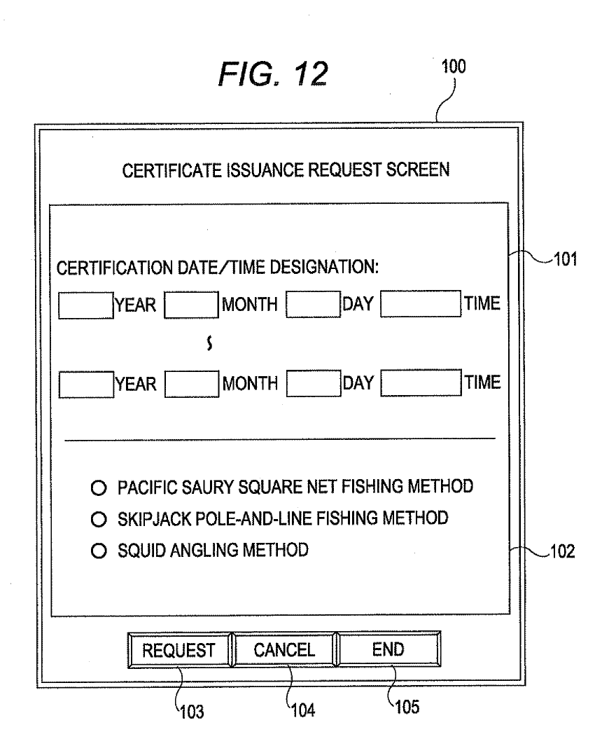

FIG. 12 is a diagram showing a display example of a certificate issuance request screen 100. The certificate issuance request screen 100 is provided with a certification date/time designation field 101 into which an operation period in which the fishing to be certified was carried out is input and a fish species/fishing method designation field 102 from which a combination of the fish species and fishing method to be certified is selected. After entries are made in these fields and a request button 103 is pressed, an issuance request including the boat number, operation period, and fish species/fishing method is generated.

If a cancel button 104 is pressed, entries in the certification date/time designation field 101 and fish species/fishing method designation field 102 are canceled. If an end button 105 is pressed, processing of the fishing boat terminal 2 is terminated.

Referring back to FIG. 11, the data transmitting unit 25 transmits the issuance request generated by processing in operation S2 and operation history information accumulated in the operation history information storage unit 23 are transmitted to the fishing certification processing apparatus 1 via, e.g., the network 3 (operation S3).

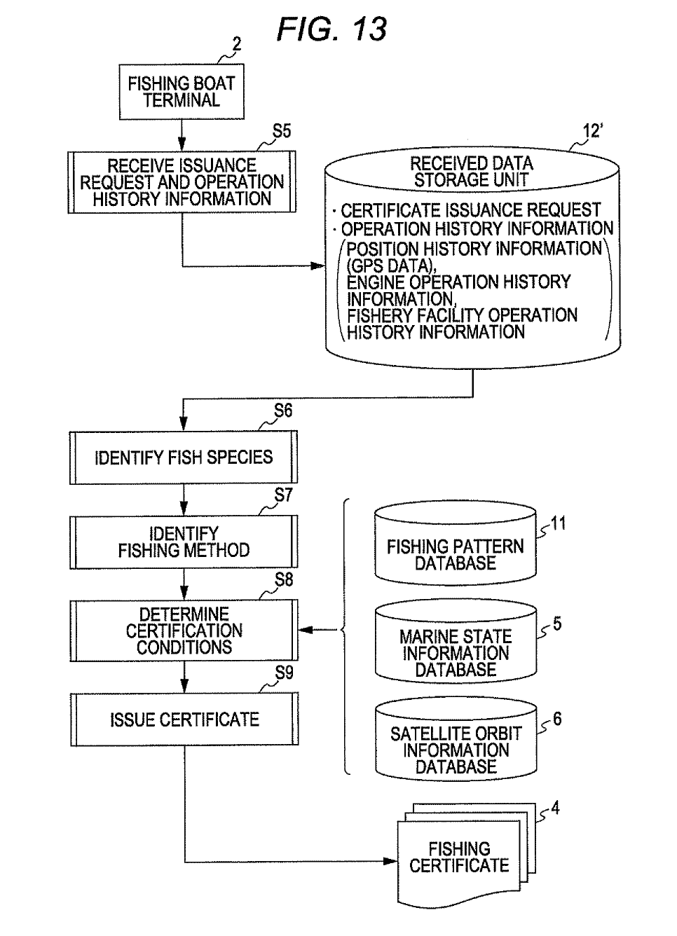

FIG. 13 is a diagram showing a flow of processing of an example fishing certification processing apparatus 1.

In the fishing certification processing apparatus 1, the data receiving unit 12 receives the issuance request of the fishing certificate 4 and operation history information transmitted from the fishing boat terminal 2 and stores them in a received data storage unit 12′ (not shown) (operation S5).

The fish species/fishing method identification unit 13 refers to the fish species/fishing method table 11a of the fishing pattern information database 11 to identify the fish species targeted for the fishing for which certificate issuance is requested and determines whether or not the operation period associated with the issuance request is within an operation permitted period of the applicable fish species (operation S6). Then, the fish species/fishing method identification unit 13 identifies the fishing method of the fish species to be certified and determines whether or not the operation period associated with the issuance request is within an operation permitted period by the applicable fishing method (operation S7). If, in processing of operation S6 or S7, the fish species or fishing method to be certified is identified, processing proceeds to operation S8. If neither fish species nor fishing method is recognized to be certified, no subsequent processing will be performed.

The certification condition determination unit 14 performs determination processing of whether to certify the fishing for which certificate issuance is requested (operation S8).

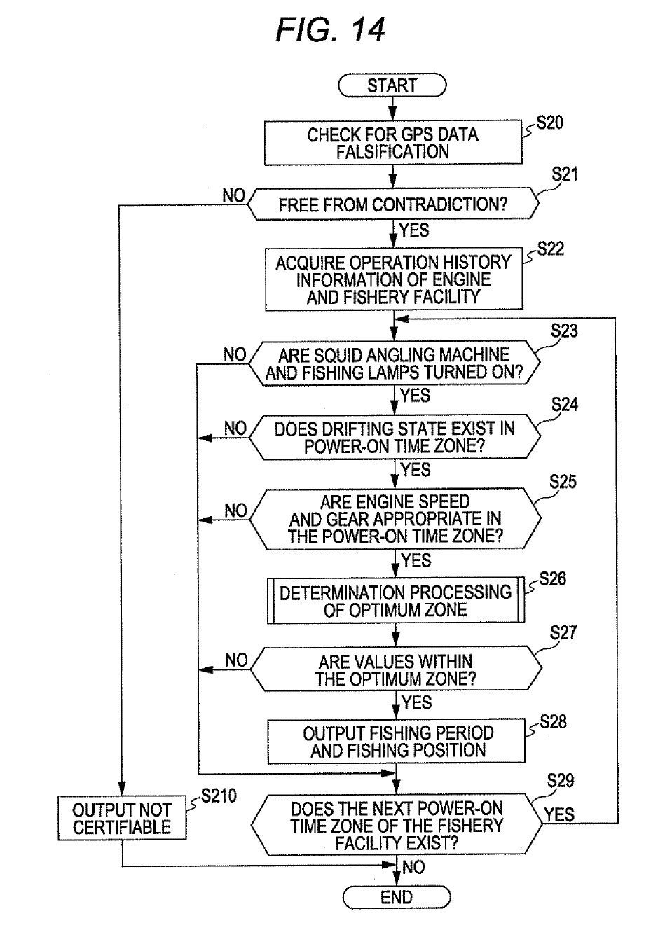

FIG. 14 is a flow diagram of certification determination processing for fishing by a squid angling method.

The position information check unit 17 checks for falsification of position in the position history information 23a (operation S20). The position information check unit 17 acquires orbit information of the GPS satellite from the satellite orbit information database 6 and calculates the position of the GPS satellite at the date/time when satellite position information extracted from position history information has been received from the acquired satellite orbit information.

Then, if there is no contradiction between the satellite position information from position history information and the calculated position information (YES in operation S21), the position information check unit 17 determines that the position history information has not been falsified and proceeds to processing in operation S22. If, on the other hand, there is a contradiction between them (NO in operation S21), the position information check unit 17 determines that the position information has been falsified. Then, the position information check unit 17 outputs “Not certifiable” (operation S210) before terminating processing.

The certification condition determination unit 14 acquires the engine operation history information 23b and the fishery facility operation history information 23c (operation S22). Then, the certification condition determination unit 14 determines whether the squid angling machine and fishing lamp are turned on from the fishery facility operation history information 23c (operation S23). Then, if the squid angling machine and fishing lamp are turned on (YES in operation S23), the certification condition determination unit 14 further determines, based on the position history information 23a, whether there is a drifting state in the time zone (power-on time zone) from power-on to power-off of the squid angling machine and fishing lamp identified from the fishery facility operation history information 23c (operation S24). The drifting state is determined based on whether movement of the position of the fishing boat in a time zone corresponding to the power-on time zone obtained from the position of the position history information 23a is within a certain distance. If movement of the position of the fishing boat is within a certain distance, it is determined that the drifting state exists.

If the drifting state exists (YES in operation S24), the certification condition determination unit 14 determines, based on the engine operation history information 23b, whether or not the engine speed and gear position in the power-on time zone are appropriate (The predetermined engine speed and the gear position are neutral) (operation S25). If the engine speed and gear position are appropriate (YES in operation S25), determination processing of an optimum zone is performed (operation S26).

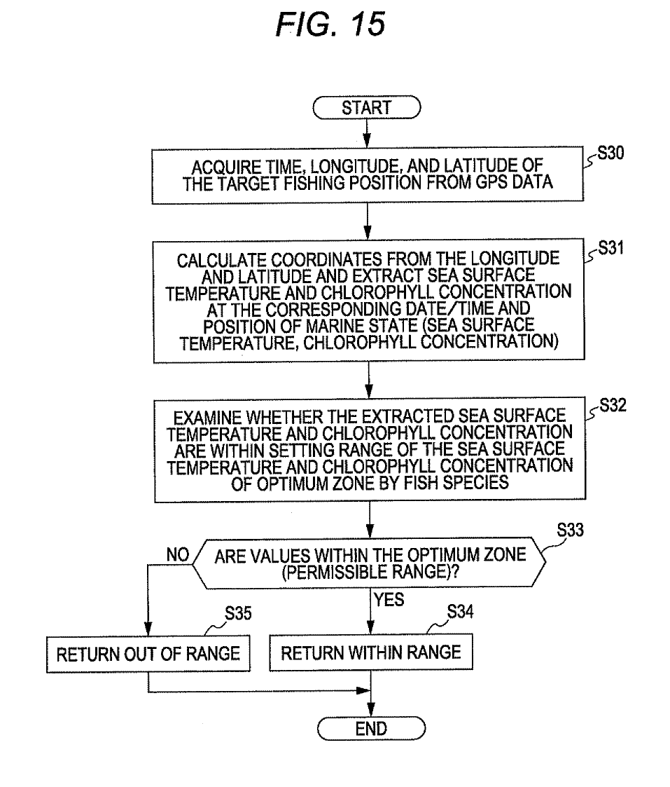

FIG. 15 is a flow diagram of determination processing of an optimum zone.

The certification condition determination unit 14 acquires “position (time, longitude, and latitude)” of the fishing boat in the power-on time zone from the position history information (GPS data) 23a (operation S30). The marine state information acquisition unit 16 converts “longitude and latitude” acquired in operation S30 to coordinates used in marine state information of the marine state information database 5. Then, the marine state information acquisition unit 16 extracts marine state information (the sea surface temperature and chlorophyll concentrations) of the measuring time and coordinates received at a time nearest to the acquired “time” (operation S31).

Then, the certification condition determination unit 14 examines whether the extracted sea surface temperature and chlorophyll concentrations are within an optimum zone (setting range) of the sea surface temperature and chlorophyll concentrations set in the optimum zone table 11c of the applicable fish species (operation S32). If values of the sea surface temperature and chlorophyll concentrations are within the optimum zone (YES in operation S33), the certification condition determination unit 14 returns “within range” (operation S34) and, if values of the sea surface temperature and chlorophyll concentrations are not within the optimum zone (NO in operation S33), the certification condition determination unit 14 returns “out of range” (operation S35).

If the result of the optimum zone determination processing in operation S26 is “within range” (within the optimum zone) (YES in operation S27), the certification condition determination unit 14 sets the power-on time zone as the fishing period and outputs, among positions of position history information, the position of a time zone corresponding to the power-on time zone as the fishing position (operation S28). Then, the certification condition determination unit 14 determines whether or not the next power-on time zone of the fishery facility exists in an operation state after the fishery facility operation history information 23c (operation S29). If the next power-on time zone exists (YES in operation S29), the certification condition determination unit 14 returns to processing of operation S23 to repeat processing of operation S23 to operation S29 for the next power-on time zone. If, on the other hand, no next power-on time zone exists (NO in operation S29), the certification condition determination unit 14 terminates processing.

If the determination result in one of processing in operations S23 to S25 and S27 is NO, processing jumps to operation S29.

Then, the certificate issuing unit 15 outputs the fishing certificate 4 using the fishing period and fishing position output in processing of operation S8 (operation S9).

The certification determination processing will be described for examples of the fish species.

Fishing by squid angling can be certified when the following conditions are satisfied:
A squid angling machine is turned on.
The engine speed is constant because fishing lamps are lit.
The gear position is neutral for maintaining the drifting state.
The position of the fishing boat is an area of sea in a marine state (sea surface temperature and chlorophyll concentrations) appropriate for the squid angling method.

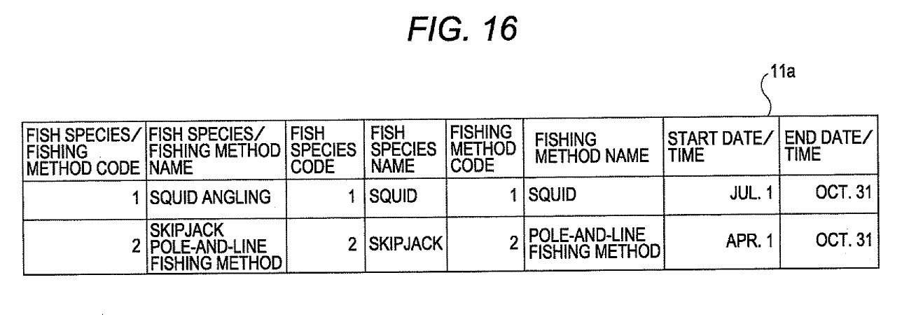

FIG. 16 is a diagram of the fish species/fishing method table 11a stored in the fishing pattern information database 11. If, for example, an operation by the squid angling method (squid fishing) carried out between 14:00 of Sep. 3, 2006 and 9:00 of Sep. 4, 2006 is to be certified in processing of operations S6 and S7 in FIG. 13, the certification condition determination unit 14 determines, in light of the fish species/fishing method table 11a, that the operation of the fish species by the fishing method is within an operation permitted period and proceeds to processing of operation S8 in FIG. 13.

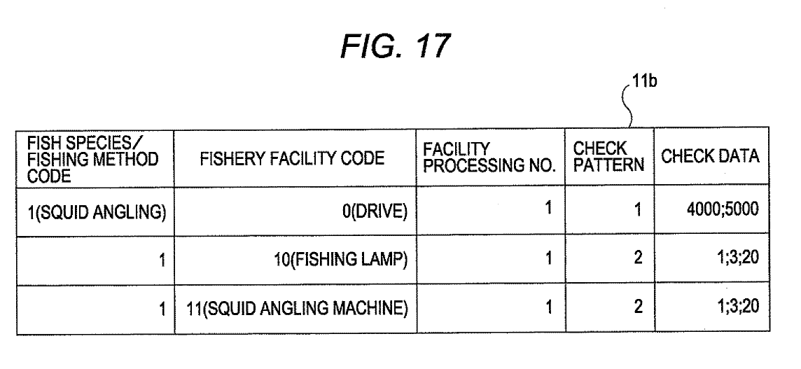

FIG. 17 illustrates an example fishing pattern table 11b. In the fishing pattern table 11b shown in FIG. 17, the check pattern and check data can be set as determination conditions for processing of each fishery facility for the fish species/fishing method “1 (squid angling)” as follows:

For Facility processing “1” (drive) of Fishery facility code of “0” (engine), the engine speed is between 4000 and 5000; for Facility processing of “1” (drive) of Fishery facility code of “10 (fishing lamp),” signal “1” (ON) and signal “3” (OFF) are issued in this order with an interval of at least 20 minutes; and for Facility processing=“1” (drive) of Fishery facility code=“11 (squid angling machine),” signal “1” (ON) and signal “3” (OFF) are issued in this order with an interval of at least 20 minutes”

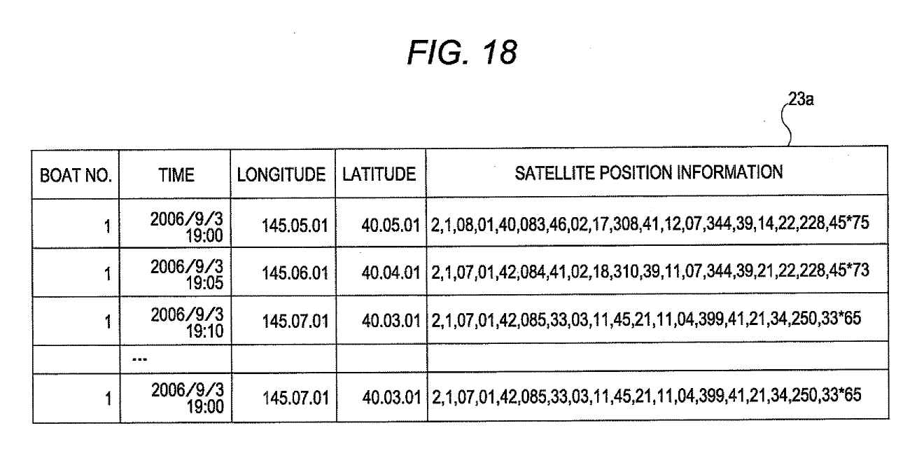

FIG. 18 is a diagram illustrating example position history information 23a. In the position history information 23a, the longitude, latitude, and satellite position information (GSV such as the number of total messages, message number, number of receivable satellites, satellite number, elevation angle, orientation, signal to noise ratio, and check sum) of the GPS signals received at every predetermined time by the fishing boat whose boat number is “1” are recorded.

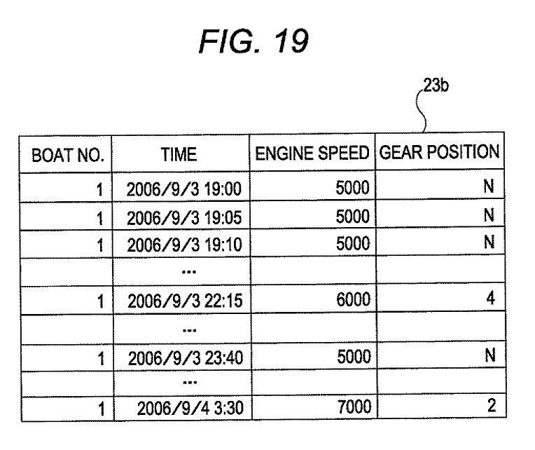

FIG. 19 is a diagram illustrating example engine operation history information 23b. In the engine operation history information 23b, the engine speed measured at every predetermined time and gear position for operation of the engine of the fishing boat whose boat number is “1” are recorded.

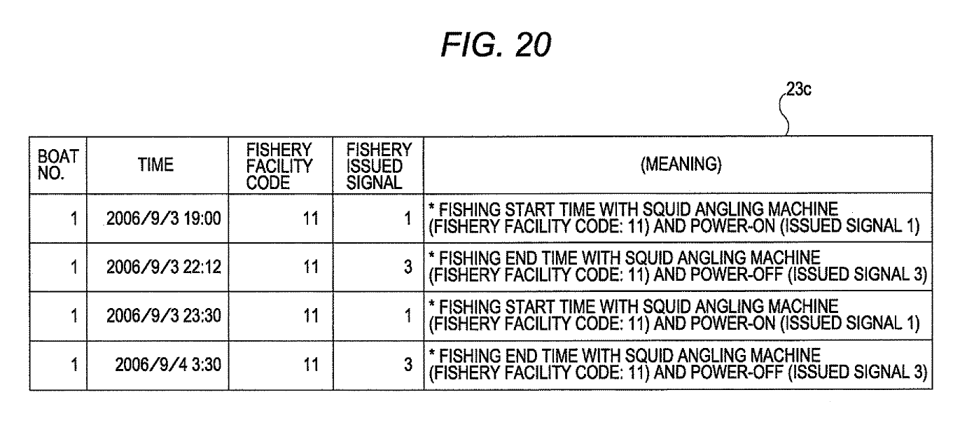

FIG. 20 is a diagram illustrating an example fishery facility operation history information 23c. In the fishery facility operation history information 23c, fishery issued signals issued by the fishery facility code=“11 (squid angling machine)” of the fishing boat whose boat number is “1” and signal issuing times are recorded.

The fishery facility operation history information 23c in FIG. 20 reveals that the fishery issued signal=“1” (power-on) has been issued at a time “19:00” of Sep. 3, 2006 by the squid angling machine (11) and the fishery issued signal of “3” (power-off) was issued at time “22:12” of Sep. 3, 2006. Since the interval between the fishery issued signals 1 and 3 is not less than 20 minutes, the operation state of the squid angling machine satisfies the check pattern and check data in the fish species/fishing method table 11a in FIG. 17 and thus, it is determined that the squid angling machine has been operating in this period (power-on time zone). It is assumed that the fishing lamp also satisfies the check pattern and check data in the fish species/fishing method table 11a and thus is determined to have been operating.

Further, from records in the engine operation history information 23b in FIG. 19, it is determined that the engine speed (5000) and gear position (neutral (N)) satisfy the check pattern and check data in the fishing pattern table 11b in FIG. 17 in the power-on time zone.

Also, from the position history information 23a in FIG. 18, if the moving distance of the fishing boat in the power-on time zone has been within a certain range, it can be determined that the fishing boat has been in a drifting state.

Thus, the power-on time zone can be determined to be an operation period from position changes of the fishing boat and operation states of the engine and fishery facility. If the engine is in the state of the engine speed (6000) and gear position (such as 2 or 4) in the engine operation history information 23b in FIG. 19, it can be presumed that the fishing boat has been moving forward (moving).

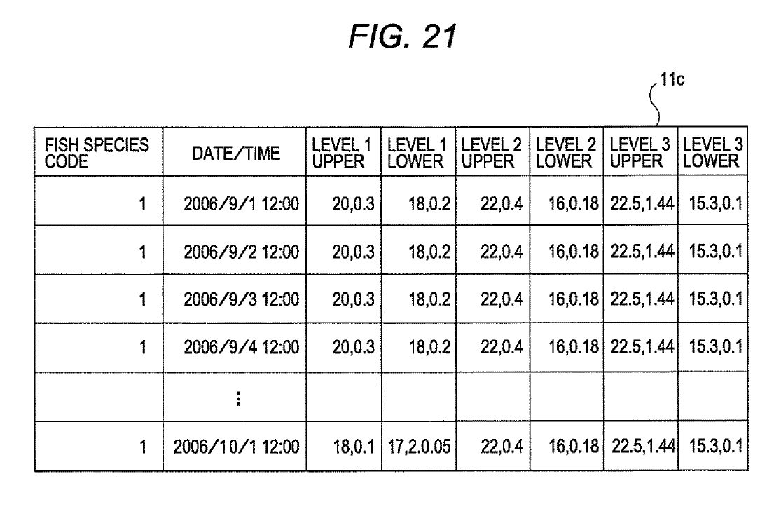

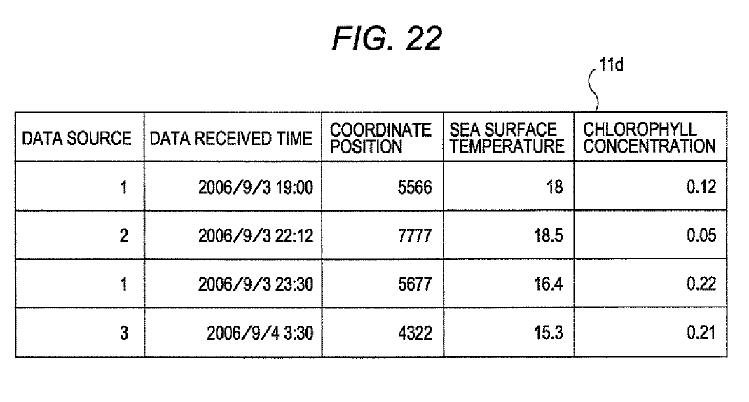

FIG. 21 is a diagram illustrating an example optimum zone table 11c. FIG. 22 is a diagram illustrating example marine state information 11d acquired from the marine state information database 5.

The position (time, longitude, and latitude) in the operation period is extracted from the position history information 23a and, based on this information, the sea surface temperature and chlorophyll concentrations at the applicable date/time and position (coordinates) are acquired from the marine state information 11d. Then, if the sea surface temperature and chlorophyll concentrations are within the optimum zone set in the optimum zone table 11c in FIG. 21, the applicable fish species can be caught and thus, the position is determined to be the fishing position.

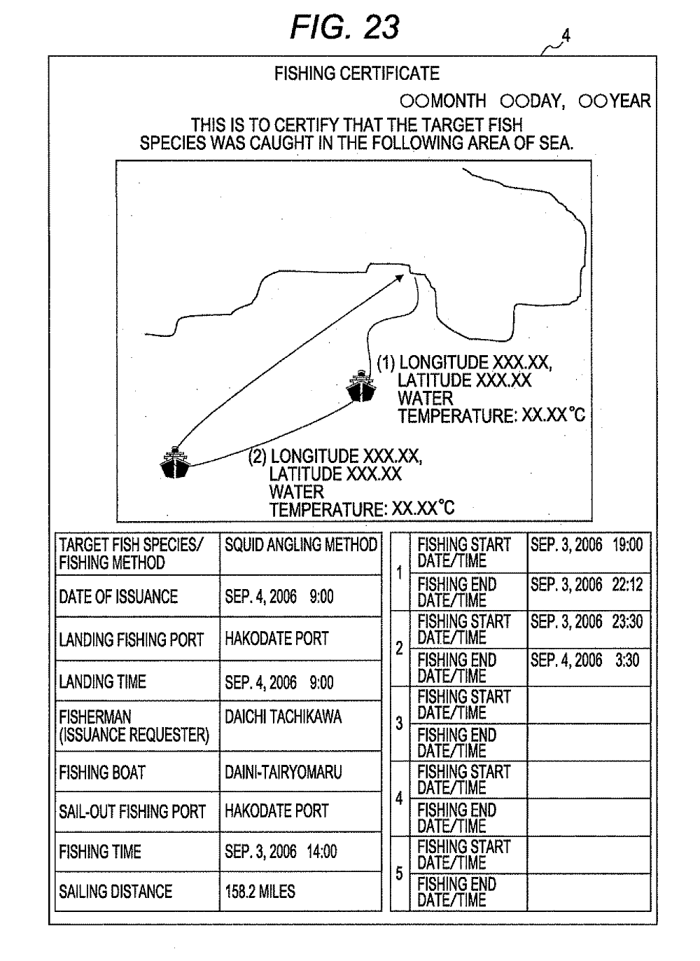

FIG. 23 illustrates an output example of the fishing certificate 4. The fish species/fishing method to be certified, name of fishing boat, fishing period (fishing start date/time and fishing end date/time), fishing position (longitude and latitude), marine state information (water temperature) and the like are output as the fishing certificate 4.

As another example, fishing by the Pacific saury square net fishing method can be certified when the following conditions are satisfied:
A square net facility is turned on.
The engine speed is constant because fishing lamps are lit.
The gear position is neutral to maintain the drifting state.
The position of the fishing boat is in an area of sea whose marine state (sea surface temperature and chlorophyll concentrations) is appropriate for the Pacific saury square net fishing method.

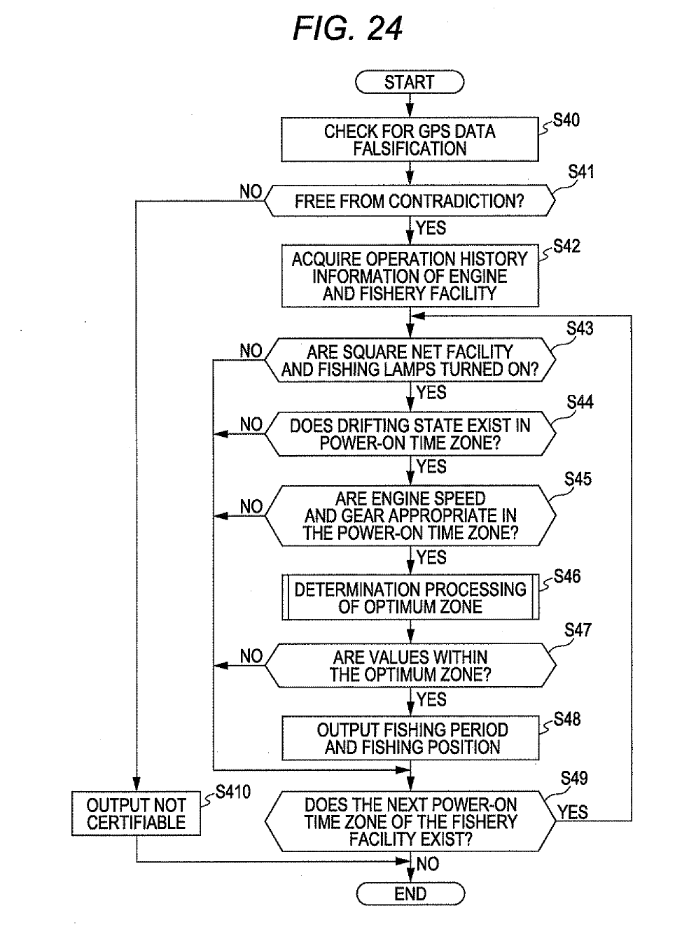

FIG. 24 is flow chart illustrating certification determination processing for fishing by the Pacific saury square net fishing method.

Processing operations S40 to S42 and S44 to S410 in FIG. 24 are similar to that of operations S20 to S22 and S24 to S210 in FIG. 14.

In operation S43, the certification condition determination unit 14 determines whether the square net facility and fishing lamps are turned on from the fishery facility operation history information 23c. If the square net facility and fishing lamps are turned on (YES in operation S43), processing proceeds to the next operation S44.

As another example, fishing by the skipjack pole-and-line fishing method can be certified when the following conditions are satisfied:
The engine speed is within a certain range and the gear is in a low speed position to maintain the speed of the fishing boat within a certain range.
A sprinkling facility is turned on.
The position of the fishing boat is in an area of sea whose marine state (sea surface temperature and chlorophyll concentrations) is appropriate for the skipjack pole-and-line fishing method.

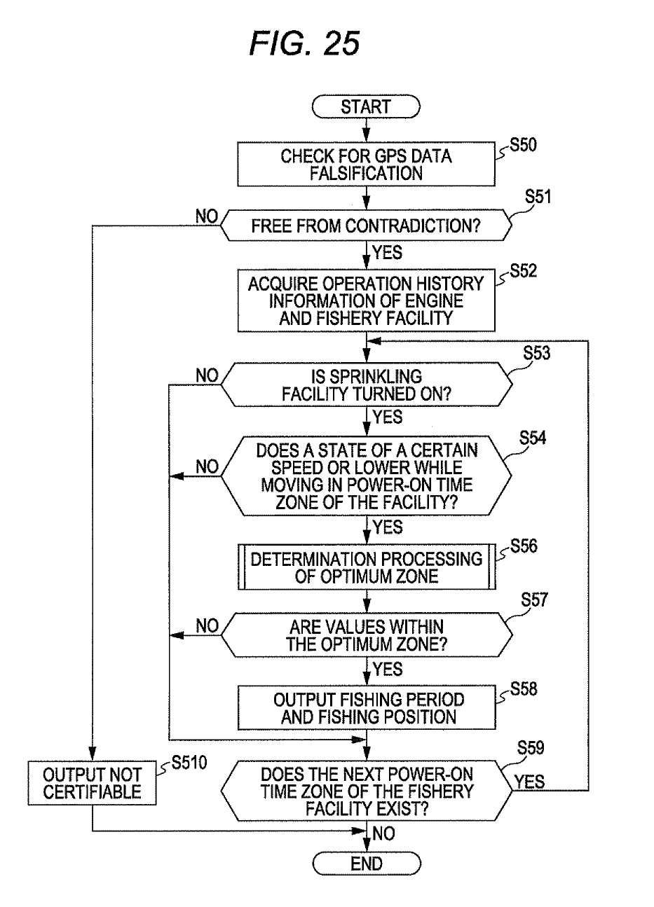

FIG. 25 is a processing flow of certification determination processing for fishing by a skipjack pole-and-line fishing method.

Processing of operations S50 to S52 and S56 to S510 in FIG. 25 is similar to that of operations S20 to S22 and S26 to S210 in FIG. 14.

In operation S53, the certification condition determination unit 14 determines whether the sprinkling facility is turned on from the fishery facility operation history information 23c. If the sprinkling facility is turned on (YES in operation S53), the certification condition determination unit 14 determines, based on the position history information 23a, whether movement of the position of the fishing boat is within a certain range in the time zone from power-on to power-off of the sprinkling facility, that is, the fishing boat is moving forward at a certain speed or lower (operation S54). If the fishing boat is moving forward at a certain speed or lower (YES in operation S54), processing proceeds to operation S56.

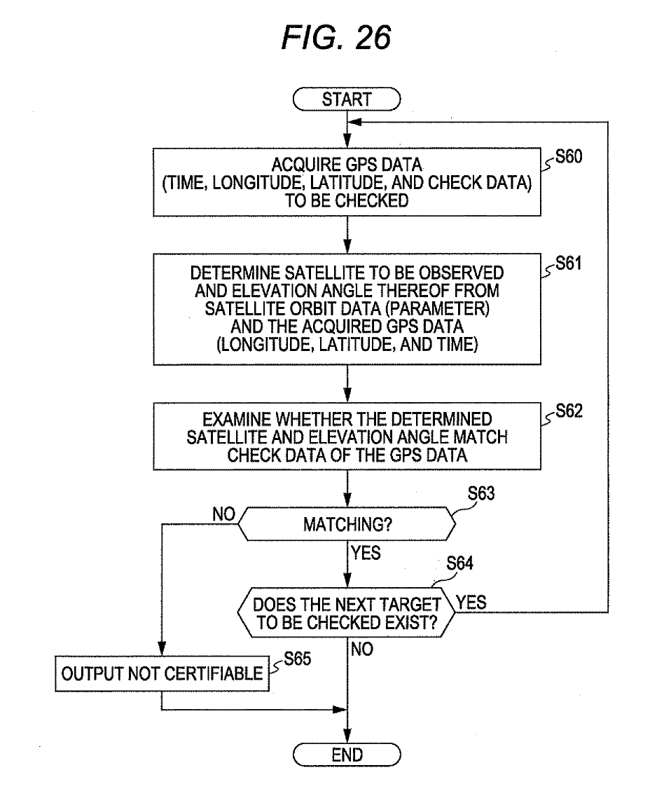

FIG. 26 is a processing flow diagram of position information check processing (such as operations S20 and S21 in FIG. 14). The position information check unit 17 acquires GPS data (time, longitude, latitude, and check data) to be checked from the position history information 23a (operation S60) and then determines the satellite to be observed and the elevation angle of the satellite from orbit information (parameters) of the GPS satellite and position history information (operation S61). The position information check unit 17 examines the determined satellite and whether the elevation angle thereof matches the elevation angle of check data of the corresponding data in the position history information (operation S62). If both angles match (YES in operation S63), the position information check unit 17 examines whether the next check target (position) exists (operation S64). If the next check target exists (YES in operation S64), processing returns to operation S60. If a next check target does not exist (NO in operation S64), processing is terminated. If, on the other hand, both angles do not match (NO in S63), “Not certifiable” is output (eS65) before processing is terminated.

Example embodiments have been described, but other embodiments can be carried out in various modifications within the scope of spirits thereof.

For example, in an example embodiment, the sea surface temperature and chlorophyll concentrations are used for measurement of the marine state in which fishing can be carried out in certification processing, but in another embodiment information used for determination of the marine state is not limited to the sea surface temperature and chlorophyll concentrations.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A fishing certification processing method by which a computer certifies a fishing period and a fishing position of aquatic animals and plants; comprising:
acquiring position history information in which positions of a fishing boat under way are recorded and operation history information in which operation states of fishery facilities of said fishing boat are recorded;
determining, after referring to a fishing pattern information storage unit for storing fish species fishing pattern information in which operation patterns of said fishery facilities while fishing predetermined aquatic animals and plants can be set, whether t there is a period in which an operation state satisfying an operation pattern in said fish species fishing pattern information is recorded in said operation history information; and
extracting, based on a determination result of said fishing pattern, positions at a time in said period of said operation state matching said fish species fishing pattern information from said position history information as said fishing positions.

2. The fishing certification processing method according to claim 1, further comprising:
identifying fishing method fishing pattern information corresponding to a species and a fishing method of an accepted aquatic animal or plant to be certified when said fishing method fishing pattern information in which an operation pattern of said fishery facilities during fishing by a predetermined fishing method is set for each species of said aquatic animals and plants is stored in said fishing pattern information storage unit, wherein
whether there is a period in which an operation state satisfying said identified fishing method fishing pattern information is recorded in said operation history information is determined in said fishing pattern determination, and
based on a determination result of said fishing pattern determination, positions at a time in said period of said operation state matching said fishing method fishing pattern information are extracted from said position history information as said fishing positions in said fishing position extraction.

3. The fishing certification processing method according to claim 1, further comprising:
acquiring marine state information in which a marine state in said fishing period at said fishing position is recorded; and
determining, after picking out said marine state of said marine state information at each position extracted in said fishing position extraction step, whether or not said marine state at each of said positions is within a marine state optimal range by referring to an optimal range storage unit storing said marine state optimal range in which said range of marine states in which said aquatic animals and plants can be fished is set, wherein
among said extracted fishing positions, only fishing positions whose marine state is within said marine state optimal range are extracted in said fishing position extraction step.

4. The fishing certification processing method according to claim 1, further comprising:
issuing a certification comprising outputting certification information identifying said fishing period and said fishing position concerning fishing of said aquatic animals and plants.

5. The fishing certification processing method according to claim 1, wherein said operation history acquisition comprises:
checking a position information comprising:
determining, when GPS information received by said fishing boat is used as said position history information, whether t said position history information has been falsified by acquiring orbit information of a GPS satellite transmitting said GPS information,
calculating said position of said GPS satellite from said orbit information, and comparing said calculated GPS satellite position and said position of said GPS position contained in said position history information, and
upon it being determined in said position information check step that said position history information has been falsified, said position history information is considered not to have been acquired in said fishing position extraction.

6. A fishing certification processing apparatus for certifying a fishing period and a fishing position of aquatic animals and plants, comprising:
an operation history acquisition unit for acquiring position history information in which positions of a fishing boat under way are recorded and operation history information in which operation states of fishery facilities of said fishing boat are recorded;
a fishing pattern information storage unit for storing fish species fishing pattern information in which operation patterns of said fishery facilities while fishing predetermined aquatic animals and plants can beset;
a fishing pattern determination unit for determining, after referring to said fishing pattern information storage unit, whether or not there is a period in which an operation state satisfying an operation pattern in said fish species fishing pattern information is recorded in said operation history information; and
a fishing position extraction unit for extracting, based on a determination result of said fishing pattern determination unit, positions at a time in said period of said operation state matching said fish species fishing pattern information from said position history information as said fishing positions.

7. The fishing certification processing apparatus according to claim 6, further comprising:
a fish species/fishing method identification unit for identifying fishing method fishing pattern information corresponding to a species and a fishing method of an accepted aquatic animal or plant to be certified when said fishing method fishing pattern information in which an operation pattern of said fishery facilities during fishing by a predetermined fishing method is set for each species of said aquatic animals and plants is stored in said fishing pattern information storage unit, wherein
said fishing pattern determination unit determines whether there is a period in which an operation state satisfying said identified fishing method fishing pattern information is recorded in said operation history information and
said fishing position extraction unit extracts, based on a determination result of said fishing pattern determination unit, positions at a time in said period of said operation state matching said fishing method fishing pattern information are extracted from said position history information as said fishing positions.

8. The fishing certification processing apparatus according to claim 6, further comprising:
a marine state acquisition unit for acquiring marine state information in which a marine state in said fishing period at said fishing position is recorded; and
an optimal range determination unit for determining, after picking out said marine state of said marine state information at each position extracted by said fishing position extraction unit, whether or not said marine state at said position is within a marine state optimal range by referring to an optimal range storage unit storing said marine state optimal range in which said range of marine states in which said aquatic animals and plants can be fished is set, wherein
said fishing position extraction unit extracts, among said extracted fishing positions, only fishing positions whose marine state is within said marine state optimal range.

9. The fishing certification processing apparatus according to claim 6, further comprising:
a certification issuing unit for outputting certification information identifying said fishing period and said fishing position concerning fishing of said aquatic animals and plants.

10. A computer readable recording medium recording a fishing certification processing program causing a computer to perform processing comprising:
operation history acquisition processing of acquiring position history information in which positions of a fishing boat under way are recorded and operation history information in which operation states of fishery facilities of said fishing boat are recorded;
fishing pattern determination processing of determining, after referring to a fishing pattern information storage unit for storing fish species fishing pattern information in which operation patterns of said fishery facilities while fishing predetermined aquatic animals and plants can be set, whether there is a period in which an operation state satisfying an operation pattern in said fish species fishing pattern information is recorded in said operation history information; and
fishing position extraction processing of extracting, based on a determination result of said fishing pattern determination processing, positions at a time in said period of said operation state matching said fish species fishing pattern information from said position history information as said fishing positions.

11. The computer readable recording medium recording a fishing certification processing program according to claim 10, causing said computer to perform
fish species/fishing method identification processing of identifying fishing method fishing pattern information corresponding to a species and a fishing method of an accepted aquatic animal or plant to be certified when said fishing method fishing pattern information in which an operation pattern of said fishery facilities during fishing by a predetermined fishing method is set for each species of said aquatic animals and plants is stored in said fishing pattern information storage unit, wherein
whether there is a period in which an operation state satisfying said identified fishing method fishing pattern information is recorded in said operation history information is determined in said fishing pattern determination processing and
based on a determination result of said fishing pattern determination processing, positions at a time in said period of said operation state matching said fishing method fishing pattern information are extracted from said position history information as said fishing positions in said fishing position extraction processing.

12. The computer readable recording medium recording a fishing certification processing program according to claim 10, causing said computer to perform
marine state acquisition processing of acquiring marine state information in which a marine state in said fishing period at said fishing position is recorded; and
optimal range determination processing of determining, after picking out said marine state of said marine state information at each position extracted in said fishing position extraction processing, whether or not said marine state at said position is within a marine state optimal range by referring to an optimal range storage unit storing said marine state optimal range in which said range of marine states in which said aquatic animals and plants can be fished is set, wherein
among said extracted fishing positions, only fishing positions whose marine state is within said marine state optimal range are extracted in said fishing position extraction processing.

13. The computer readable recording medium recording a fishing certification processing program according to claim 10, causing said computer to perform
certification issuing processing of outputting certification information identifying said fishing period and said fishing position concerning fishing of said aquatic animals and plants.
